(19) United States
(12) Patent Application Publication
(10) Pub. No.: US 2016/0243776 A1
(43) Pub. Date: Aug. 25, 2016

(54) Compression Tires and Tire Systems

(71) Applicant: Michel Energy, Inc., Solvang, CA (US)

(72) Inventor: Chuck Michel, Solvang, CA (US)

(21) Appl. No.: 14/949,791

(22) Filed: Nov. 23, 2015

Related U.S. Application Data
(63) Continuation of application No. PCT/US2014/038481, filed on May 16, 2014.
(60) Provisional application No. 61/826,887, filed on May 23, 2013.

(51) Int. Cl. B29D 30/00; H02K 7/18; B60C 19/00

(52) U.S. Cl. CPC B29D 30/0061; B60C 19/00; H02K 7/1846; B29D 2030/0094

(57) ABSTRACT

Air compressing tires on a vehicle can utilize tire deformation during vehicle motion to compress a gas. The compressed gas can be discharged from the tire to a pressure regulating vessel on the vehicle. The compressed gas can be stored or used for power generation on board the vehicle. In some cases, the power generated can be used to extend battery power and/or range of an electric vehicle.

### CROSS-REFERENCE

This application is a continuation application of International Application No. PCT/US2014/038481, filed May 16, 2014, which application claims the benefit of U.S. Provisional Patent Application Ser. No. 61/826,887, filed May 23, 2013, each of which is entirely incorporated herein by reference.

### BACKGROUND

A tire or wheel is a ring-shaped covering that fits around a rim on a vehicle. Tires and wheels, such as those for automobiles, trucks and railroad cars, provide traction between the vehicle and a road or rail track while providing a flexible cushion that absorbs shock.

### SUMMARY

The present disclosure provides devices and systems for compressing air or other gas(es) on a vehicle with the aid of the rotary motion of one or more tires of the vehicle. On a railroad car, a tire can be a solid steel or composite wheel cushioned with a spring system. Systems of the present disclosure can be used to compress tires on vehicles to generate a pressure drop. The pressure drop can be used to effect fluid flow through a fluid flow path on board the vehicle. The fluid flow path can be in fluid communication with a storage vessel that is configured to store pressurized air on the vehicle, which can be used, for example, to generate power onboard the vehicle. As an alternative, or in addition, the fluid flow path can be in fluid communication with a power generator or power generation system (e.g., turbine) that is configured to generate power from the pressurized air. In some cases, the power generation system is a separate from a motor of the vehicle. The motor can be configured to provide motion to the vehicle. As an alternative, the power generation system is integrated with the motor.

Systems of the present disclosure include tires that are configured to deform and generate compressed air or other gas(es). The tires can each include a compression tube and a compressing bladder. The tires can utilize tire deformation during vehicle motion to compress air or effect the flow of air through a fluid flow channel. On a steel, other metal, or composite railroad car wheel, compression from railroad car weight can be achieved using a compressing yoke. The compressing yoke can compress a compression chamber comprising a fluid, for example, ambient air, oxygen, nitrogen, or a mixture of gases. The compressed air can be discharged from the tire to a pressure regulating vessel on a vehicle. The compressed air can be stored or used for power generation on board the vehicle. In some cases, the power generated can be used to provide power to a battery charging system onboard the vehicle, which can aid in extending battery power and/or range of the electric vehicle.

Recognized herein is the utility of tire deformation resulting from the vehicle's own weight as a way to provide compressed air to vehicles. Tires and tire systems of the present disclosure can use tire deformation without altering standard tire tread design, where standard design refers to commercially available tread designs.

An aspect of the present disclosure provides an air compressing tire on a vehicle, comprising a compressing bladder, a compression chamber, and a fluid path for transferring air from the compression chamber to the vehicle, wherein the air is compressed by a weight force from the vehicle transmitted to the compression chamber by the compressing bladder.

An aspect of the present disclosure provides an air compressing system on a vehicle that comprises (a) a tire, the tire comprising (i) a rim, (ii) a compressing bladder circumscribing at least a portion of the rim, and (iii) a compression chamber circumscribing at least a portion of the compressing bladder. The compression chamber can be configured to generate compressed air by a force from the vehicle that is transmitted to the compression chamber by the compressing bladder. The system can further comprise a fluid flow path in fluid communication with the compression chamber. The fluid flow path can be for transferring air from the compression chamber to the vehicle during motion of the vehicle. In an embodiment, the tire is a standard tire or a railroad car wheel. The air compressing system can be on a vehicle such as an automobile or a train.

In an embodiment, the fluid flow path is a closed circulatory fluid flow path

In an embodiment, the system further comprises one or more additional tires that can each comprise an additional rim, an additional compressing bladder circumscribing at least a portion of the additional rim, and an additional compression chamber circumscribing at least a portion of the additional compressing bladder. The one or more additional tires can comprise at least two additional tires.

In an embodiment, the system further comprises an additional compression chamber. The additional compression chamber can be in fluid communication with the fluid flow path or an additional fluid flow path. The additional compression chamber can circumscribe at least a portion, all of, or substantially all of the compressing bladder or an additional compressing bladder. The compressing bladder can be rigid, hollow, or solid. The compressing bladder can be formed of a polymeric material, a metallic material, or a composite material.

In an embodiment, the system further comprises a power generation system that is in fluid communication with the fluid flow path. The power generation system can generate power upon fluid flow through the fluid flow path by using the compressed air.

Another aspect of the present disclosure provides a power generation system onboard a vehicle that comprises at least one vehicle tire. The vehicle tire comprises (i) a rim, (ii) a compressing bladder that circumscribes at least a portion of the rim, and (iii) a compression chamber that circumscribes at least a portion of the compressing bladder. The rotation of the vehicle tire can generate a periodic force that can be directed to the compression chamber through the compressing bladder. The periodic force can compress fluid in the compression chamber. The system further comprises a fluid flow path in fluid communication with the compression chamber. The fluid flow path can be adapted to direct compressed fluid out of the compression chamber. The system further comprises a power generation system that can be in fluid communication with the compression chamber through the fluid flow path. The power generation system can be adapted to generate power upon fluid flow through the fluid flow path. The fluid flow can be generated upon compression of fluid in the compression chamber upon rotation of the vehicle tire.

In an embodiment, the tire is a standard tire or a railroad car wheel. The compression bladder can be formed from polymeric material, a metallic material, or a composite material. The compression bladder can be hollow or solid.

In an embodiment, the system further comprises a compression chamber that is in fluid communication with the ambient environment through a first opening and in fluid communication with the fluid flow path through a second opening. The vehicle tire can be configured and adapted such that, during rotation of the vehicle tire, fluid is directed into the compression chamber. The fluid can then be directed through the first opening upon displacement of fluid from the compression chamber and into the fluid flow path through the second opening.

Another aspect of the present disclosure provides a method for generating power onboard a vehicle that comprises at least one tire that can include (i) a rim, (ii) a compressing bladder circumscribing at least a portion of the rim, (iii) a compression chamber circumscribing at least a portion of the compressing bladder, and (iv) a fluid flow path that can be in fluid communication with the compression chamber and a power generation system. The power generation system can generate power from fluid flow through the fluid flow path. The method can further comprise using rotation of the tire to cause the compression of the compressing bladder against the rim, thereby displacing fluid from the compression chamber into the fluid flow path. The displaced fluid can then be directed from the compression chamber to the power generation system through the fluid flow path in order to generate power upon the rotation of the tire.

In an embodiment, during rotation of the tire, fluid in the compression chamber is compressed and discharged to a pressure regulating vessel on board the vehicle and in fluid communication with the fluid flow path.

In an embodiment, the compression chamber is in fluid communication with the ambient environment through a first opening and in fluid communication with the fluid flow path through a second opening. The vehicle tire can be configured and adapted such that, during rotation of the vehicle tire, fluid is directed into the compression chamber. The fluid can then be directed through the first opening upon displacement of fluid from the compression chamber and into the fluid flow path through the second opening. The first opening and/or the second opening can comprise at least one one-way valve, where the on-way valve can permit flow of fluid only in one flow direction.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings or figures (also “FIG.” and “FIGs.” herein), of which:

FIG. 1 is a cross-sectional side view of a rotating air compressing tire deformed by vehicle weight and in fluid communication with a pressure regulating vessel.

FIG. 2 is a cross-sectional side view of the rotating air compressing tire in FIG. 1.

FIG. 3 is a cross-sectional view perpendicular to the axis of rotation of the air compressing tire in FIG. 1.

FIG. 4 is a cross-sectional side view of a rotating air compressing tire with multiple compression cells.

FIG. 5 is perspective view of a run flat tire with a run flat ring attached to the tire rim inside the tire.

FIG. 6 shows cross-sectional side views of a rotating railroad car wheel with a yoke and a compression chamber (or bladder).

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed. It shall be understood that different aspects of the invention can be appreciated individually, collectively, or in combination with each other.

The disclosure provides air compressing devices and systems that can be used in air compressing tires on vehicles. A tire generally includes a tire tread for traction against a road surface. An inside edge of the tire can be mounted on a tire rim that forms an outer edge of a wheel. The tire can have a standard tread design, which may be subject to regulation by a regulating government authority. Contact of the tire with the road can vary depending on tread design and tire inflation, wherein both under-inflated and over-inflated tires have less solid contact with the road, resulting in less grip. Thus, maintaining proper tire configuration for a given tread design can ensure proper grip of the tire against the road surface.

The air compressing tires of the disclosure can be used in any vehicle, including, for example, scooters, motorcycles, cars, trucks, airplanes, or any other vehicle utilizing rotating tires during vehicle motion. The vehicles can be propelled by one or more power generation (or conversion) devices, including electric engines, electrochemical engines, combustion engines (e.g., internal combustion engines, turbines), or any other power generation devices, or combinations thereof. The one or more power generation devices may be coupled to a motor (e.g., a battery may be coupled to an electric motor), a drivetrain, or any combination thereof. The wheels may be clad with tires. In some cases, the wheels may not be clad with tires, wherein the wheels themselves perform the function of the tires. The tires may be air-filled tires or air-less tires. An air-filed tire can comprise a sealed air-filled chamber between the tire surface and the tire rim. An air-less tire can comprise, for example, carbon fiber cells (or an alternative suitable structural material) mounted between the tire rim and the tire tread. The weight of the vehicle can provide a crushing force on each tire, thereby compressing the portion in a region contacting the road surface. As both air-filled and air-less tires can experience this crushing force, the air compressing devices and systems of the disclosure can be applied regardless of tire type.

The air compressing tires of the disclosure can be mounted to a vehicle's rigid tire rim interior, and can include a compressing bladder and one or more compression tubes, cells, or pistons inside the tires on the vehicle. The compressing bladder may be rigid, such that the vehicle's weight on the tires can force the rigid compressing bladder against the rigid tire rim and squeeze the compression tubes or cells inside the tire such that air (or other gas) inside the compression tubes or cells is compressed. Upon compression, the air can experience an increase in pressure. The compressed air inside the confined space of the compression tubes or cells can then be transferred out of the tire while the vehicle is traveling and the tires are rotating on the road surface. As the vehicle travels, the tires rotate in contact with the hard road surface. The weight of the vehicle on the tires crushes the tires against the hard road surface. This crushing weight (force) provides the force for compressing the air (or other fluid) inside the compression tubes or cells, thus transferring energy to the compressed air.

The present disclosure provides tire systems that are configured to be installed on a vehicle, such as by retrofitting a vehicle. Tire systems of the present disclosure can include one or more tires with one or more chambers that are configured to compress (also “compression chambers” herein). The tire can include a bladder (also “compressing bladder” herein) that is configured to compress a given compression chamber, such as by providing a force having at least a portion of the weight of the vehicle against the given compression chamber. The given compression chamber can be adjacent to the compressing bladder. In some cases, the given compression chamber circumscribes at least a portion or the entirety of the compressing bladder.

The tire can include a rim that is configured to provide structural support to the tire. The compressing bladder can be adjacent to the rim. In some cases, the compressing bladder can circumscribe at least a portion or the entirety of the rim.

The given compression chamber of a tire is configured to deform and compress a gas (e.g., air) inside the compression chamber by utilizing the weight of the vehicle. The given compression chamber can be in fluid communication with a fluid flow path leading from the compression chamber to, for example, a gas storage chamber and/or a motor (e.g., turbine). The gas storage chamber or turbine can be mounted on the vehicle. During motion of the vehicle, the compression chamber can deform and compress a gas in the compressing bladder, which compression can drive fluid flow from the compressing bladder through the fluid flow path. The tire with one or more compressing bladders, therefore, can effectively act as a compressor during motion of the vehicle.

Reference will now be made to the figures, wherein like numerals refer to like parts throughout. It will be appreciated that the figures (and features therein) are not necessarily drawn to scale.

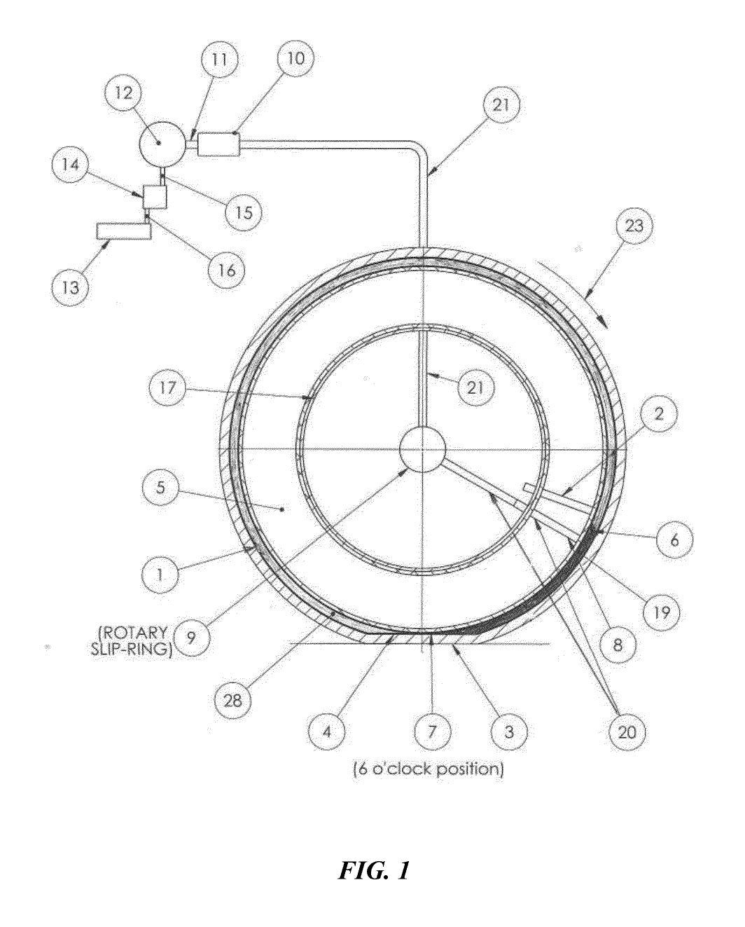

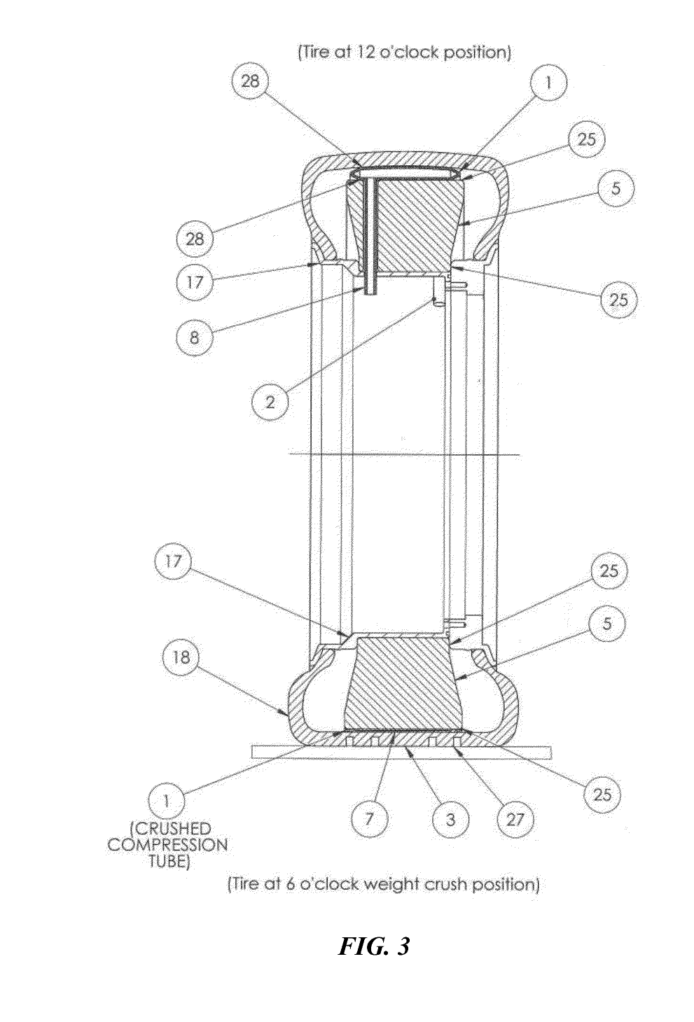

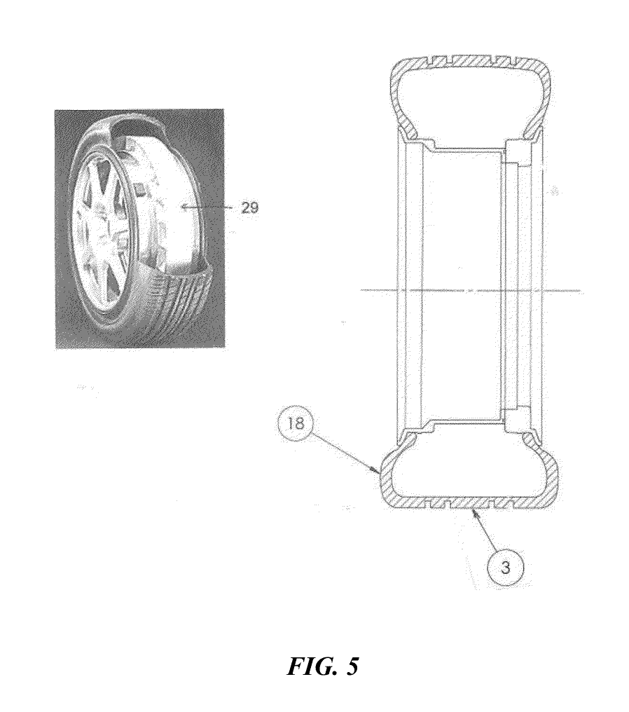

FIG. 1 is a cross-sectional side view of an air compressing tire rotating in clockwise tire rotation direction 23. The air compressing tire can be in fluid communication with a pressure regulating vessel 10. The weight of a vehicle (not shown) on the tire can create a footprint or distortion in the tire at a road contact point 3. The weight can crush a compression tube 1 at a squeeze (crush or pinch) point 7 at the 6 o'clock position of the rotating tire (as indicated in FIG. 1). Due to the weight (force) of the vehicle, the compression tube 1 and a rigid compressing bladder 5 are squeezed (compressed) with each tire rotation (at positions 3, 7) against a rigid (or non-deformable) or substantially rigid tire rim 17, against tire interior surface at the 6 o'clock position (e.g., deformed side walls 18 in FIGS. 3 and 5), and against the road surface 3. The weight of the vehicle can crush the tire to a flat spot on the bottom 7 and crush (or pinch) the compression tube 1 inside the tire between the rigid compressing bladder 5 and an enclosure 4, thereby compressing air inside the compression tube 1 as the tire rotates during travel. The enclosure 4 may comprise one or more portions of tire material. For example, the enclosure may comprise an inwardly facing surface of the tire material that contacts the road surface. The tire material that contacts the road surface may comprise multiple layers. The layers may be integrally formed, or separate. In some cases, an inwardly facing layer provides the enclosure 4. In some cases, the enclosure may comprise one or more layers. For example, the enclosure may comprise standard, commercially available, tire tread, such as, for example, all weather tire treads, off-road tire treads, high performance sport tire treads, reinforced tire treads for puncture resistance, and comfort tire treads. The enclosure may create a rigid compression wall on the bottom of the tire (i.e., at the 6 o'clock position 7). Thus, the compression tube can be crushed between two rigid compression walls at positions 3, 7 (rigid compressing bladder (or yoke) 5 and enclosure 4 squeezed against the road surface). In some cases, in the absence of such rigid compression walls (e.g., when one or more of the compression walls is of a non-rigid construction, such as compression walls that may soften or flex as the tire heats due to road traction), the compression of the air inside the compression tube may be diminished, may be inconsistent, or may even be eliminated.

As the tire rotates, the compression tube 1 and a rigid compressing bladder 5 can be squeezed (compressed) periodically, such as once per each revolution of the tire. Such periodic compression can generate compressed air on a periodic basis. In a given period of travel, the tube 1 and bladder 5 can be compressed at a frequency (number of compressions per unit time) that can be determined by the velocity of travel divided by the circumference of the tire, or v (kilometers/hour) divided by pi (3.14)*the diameter of the tire. For example for a car that is travelling at 100 kilometers per hour (kph) and having a tire that is 0.6 meters in diameter, the tube 1 and bladder 5 can be compressed at a frequency of once every 100 kph*1000 meter/kilometers/(3.14*0.6)=53,078 compressions per hour (or 14 compressions per second).

The compression at the 6 o'clock position 7 can force the air in the compression tube 1 against one or more air dams or seals 6 inside the compression tube. The air in the compression tube can be displaced as the tire rotates and at least partially or fully squeezes the compression tube, which decreases the volume of the compression tube containing the fluid. Not having any other outlet, this displaced air can be forced against the air dam or seal 6 inside the compression tube, resulting in increasing air pressure. As the tire rotates, the confining space 19 between the 6 o'clock position 7 and the air dam (seal) 6 can decrease, and the air pressure increases as the 6 o'clock position 7 can move successively closer to the position of the air dam (seal) 6. Thus, as the confining space between the air dam (seal) 6 and the pinching road surface 7 shrinks, the pressure of the compressed air in the compression tube 1 can rise. The pressure increase may be by a factor of at least about 2, 3, 4, 5, 10, 15, 20, 30, 50, 100, 200, 300, 400, 500, 100, 10000, or 100000 (with respect to an initial pressure).

A pressure valve can discharge the compressed air from the confining space 19 through a discharge stem 8 attached to the compression tube 1. The pressure valve in the discharge stem 8 may discharge the compressed air at a given (e.g., predetermined) rate and/or at a given (e.g., predetermined) pressure. In some cases, all of the compressed air in the confining space 19 can be discharged for each tire rotation. In other cases, a portion of the compressed air in the confining space 19 can be discharged for each tire rotation. In yet other cases, none of the compressed air in the confining space 19 can be discharged during a given tire rotation, and at least a portion of the compressed air can be released during one or more subsequent tire rotations. The compressed air may be discharged at a predetermined pressure. This pressure may correspond to a given position of the pinching road surface 7 with respect to the air dam (seal) 6 that corresponds to the predetermined compressed air pressure. For example, the compressed air may be discharged when the air dam (seal) 6 has rotated clockwise to a position adjacent to the pinching road surface 7. In some cases, this position may correspond to the maximum air compression achievable per tire revolution.

In some cases, the pressure valve may comprise a one-way check valve to ensure that compressed air can be discharged from the compression tube, but that no air can be drawn into the compression tube via the discharge stem 8. In other cases, a two-way valve or multiple one-way valves (e.g., with different predetermined discharge pressures) may be used instead, allowing air to be discharged as well as drawn into the compression tube via the discharge stem 8. The outflow of the compressed air from the discharge stem 8 may be channeled out of the tire area through tubing 20 to a rotating valve 9 in the spinning tire. From there, the outflow of the compressed air may be channeled through an axle of the vehicle via stationary tubing 21 in the axle. In some embodiments, the compressed air can be discharged to a pressure regulating vessel 10 on board the vehicle (i.e., outside the tire). The rotating valve 9 can be a sealed valve that allows the spinning wheel and tire to transfer the compressed air through the stationary tubing system 21 to the stationary pressure regulating vessel 10 in the vehicle. In one example, the rotating valve 9 can comprise a first cylindrical member in connection with a second cylindrical member. The first cylindrical member can comprise an opening in fluid communication with tubing 20. The second cylindrical member can comprise an opening in fluid communication with tubing 21. The first cylindrical member can be configured to rotate with respect to the second cylindrical member. A seal (e.g., gasket) can be provided to seal a chamber between the first cylindrical member and the second cylindrical member. In some examples, the rotating valve 9 can comprise a rotary slip-ring.

In some examples, the air compressing tire of FIG. 1 can be in fluid communication with a gas storage chamber for holding or containing a gas provided by the air compressing tire. As an alternative, or in addition, the air compressing tire can be in fluid communication with a power generator, which may be part of, or installed on board of, the vehicle.

The air compressing tire can be part of a fluid flow path configured to provide compressed air. The fluid flow path can be a one-way fluid flow path leading from the air compressing tire to the vehicle, or a circulatory fluid flow path leading from the air compressing tire to the vehicle and back to the air compressing tire. A circulatory fluid flow path may be used, for example, in cases in which pressurized air in the air compressing tire is used to drive a power generator on board the vehicle. The circulatory fluid flow path may be a closed circulatory flow path, which may include one or more turbines for generating power upon flow of fluid through the fluid flow path.

The vehicle can include at least 1, 2, 3, 4, 5, 6, 7, 8, 9, 10 or more air compressing tires. The vehicle can include air compressing tires and standard tires. For example, a vehicle with four tires can include 1, 2 or 3 air compressing tires, and the balance standard tires. The vehicle can include at least 1, 2, 3, 4, 5, 6, 7, 8, 9, 10, 11, 12, 13, 14, 15, 16, 17. 18. 19, 20, 25, 30, 35, 40, 50, 75, 100, 200, 500 or more air compression chambers, compression tubes, compression cells, or a combination thereof. The compression chambers/tubes/cells can be distributed over one or more tires.

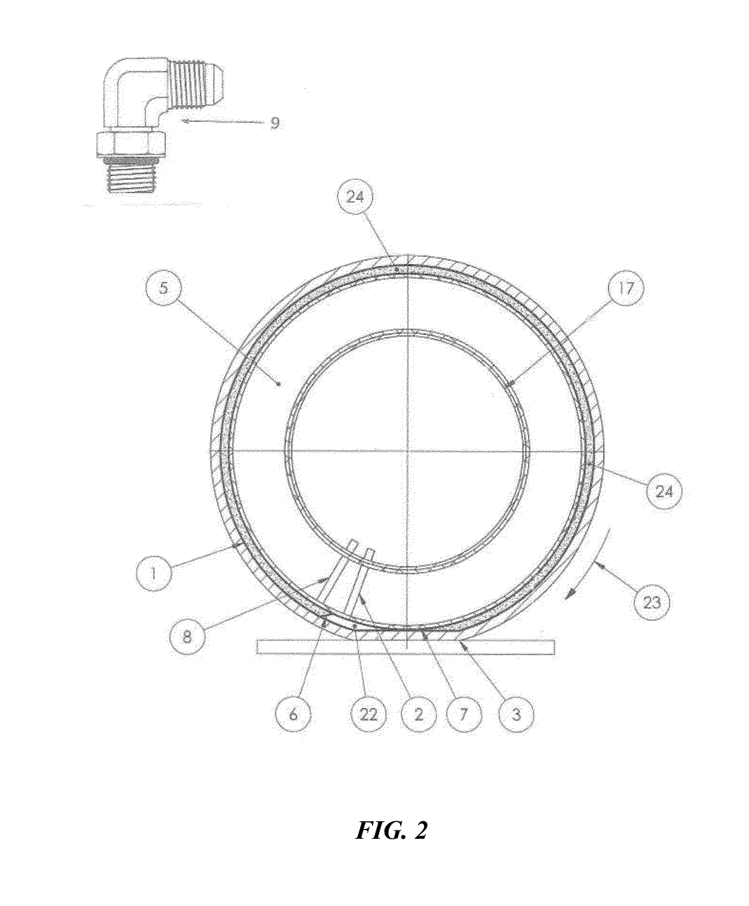

FIG. 2 is a cross-sectional side view of the rotating air compressing tire in FIG. 1, rotated clockwise to a position in which the air dam or seal 6 has passed the pinch point 7 at the 6 o'clock position. As the tire rotates beyond the 6 o'clock position, the confining space 22 of the compression tube 1 can have released at least a portion or all of its compressed air. The compression tube 1 can be vulcanized to the tire and the compressing bladder 5 (e.g., at attachment points 28 shown in FIG. 3). As a result, as the tire rotates past the pinch point 7, the empty compression tube can be pulled apart, wherein a vacuum is created in the empty volume of the compression tube 1. The vacuum in the compression tube can begin to suck in ambient air through an intake stem 2. The ambient air can be drawn into the compression tube from an air volume outside of the tire. For example, when an air-filled vehicle tire is used, the ambient air can be drawn from an air volume outside of the tire, so as not to change air pressure inside the air-filled tire. The intake stem may comprise a one-way check valve to ensure that ambient air can pass into the compression tube, but that compressed air cannot pass from the compression tube to the surroundings.

As the tire continues to rotate in the clockwise tire rotation direction 23 past the pinch point 7, ambient air can be continuously drawn into the confining space 22 (compression tube space between the pinch point 7 and the dam or seal 6, in clockwise direction) while compression begins anew in a confining space 24 (compression tube space between the dam or seal 6 and the pinch point 7, in clockwise direction) as subsequent portions of the compression tube 1 move past the pinch point 7, thus forcing the air inside the compression tube against the air dam (seal) 6. The confining space 22 can be in fluid communication with at least one intake stem 2, while the confining space 24 (analogous to the confining space 19 in FIG. 1) can be in fluid communication with at least one discharge stem 8. With each revolution of the tire, the pinch point 7 at the 6 o'clock position caused by the vehicle's weight creates a peristaltic pumping action which continually compresses the compression tube.

With reference to FIG. 1, the compressed air can be discharged to a pressure regulating vessel 10, which may collect and regulate the compressed air to a predetermined high pressure state.

The pressure regulating vessel 10 can comprise an overflow relief valve (not shown) to expel excess compressed air and/or a backflow check valve (not shown) for maintaining the compressed air pressure in the vessel. The pressure regulating vessel 10 can further comprise an outflow orifice 11 for discharging the regulated compressed air.

The compressed air maintained in the pressure regulating vessel 10 may be used for storing energy on board the vehicle and/or for providing power on board the vehicle through the use of the compressed air in one or more power generation devices or systems. For example, the compressed air may be discharged to one or more air motors or air turbines 12. The compressed air can be discharged directly from the pressure regulating vessel 10 via the outflow orifice 11 to the air motor(s) or air turbine(s) 12. In some cases, the compressed air can be discharged directly to one or more of the power generation device(s) or system(s) 12 (i.e., bypassing the pressure regulating vessel). The need for using the pressure regulating vessel prior to discharge into downstream devices may be given by the flexibility in operating pressure of the downstream device.

In some embodiments, the power generation device(s) or system(s) 12 may be used to propel the vehicle. For example, the air motor may be used in a compressed air propulsion system on board the vehicle. In this example, the air motor may be coupled to the vehicle's drivetrain.

In some embodiments, the power generation device(s) or system(s) 12 can drive one or more generators or alternators 13 for converting mechanical power to electric power. The generators/alternators can be part of an electric charging system for recharging one or more batteries. Such recharging capability may be used to recharge a vehicle's battery system to extend driving range, such as, for example, on board hybrid electric vehicles (HEVs), plug-in hybrid electric vehicles (PHEVs) or electric vehicles (EVs). Thus, the devices and systems of the disclosure can be used to increase driving range without generating additional polluting exhaust gases and without additional fuel expense (i.e., without the need to consume additional fuel).

In some cases, the generators/alternators can be directly coupled to the power generation device(s) or system(s) 12. In other cases, the generators/alternators may need to be coupled to the power generation device(s) or system(s) 12 via a transforming device/system in order to generate power with characteristics suitable for the electric charging system (or any other electric system coupled to the generators/alternators).

In some embodiments, a step-up or step-down gear box system 14 may be used. The gear box system 14 may be connected to an input spindle 15 and an output spindle 16. The gear box system may be configured (e.g., calibrated, dimensioned) to achieve a predetermined output spindle rotation speed (e.g., a predetermined number of revolutions per minute). For example, the air motor or air turbine 12 may be connected to the input spindle 15, and the output spindle 16 may drive the generator or alternator 13. The gearing may be configured to spin the output spindle at an appropriate speed for the generator or alternator, or any other spinning or rotating device or system which may be coupled to the output spindle.

In yet other embodiments, the compressed air in the pressure regulating vessel 10 may be used as an energy storage system on board the vehicle. For example, at least a portion of the compressed air in the pressure regulating vessel may not be discharged on board the vehicle, but may instead be used as a power station (e.g., one or more home power stations, one or more commercial power stations, or any combination thereof). In some cases, the compressed air may be discharged from the pressure regulating vessel into storage cylinders or vessels (e.g., sixpacks of air) at a predetermined pressure. A vehicle may carry a least 1, 2, 3, 4, 5, 10, 20, 30, 40, 50, or 100 storage cylinders or vessels. The stored compressed air can then be discharged to provide power at a later point in time. In some cases, the total capacity for storing compressed gas (e.g., air) on board the vehicle may be varied with time. For example, one or more storage cylinders or vessels may be added to the vehicle additional storage capacity. In some cases, the fraction of the total capacity available for storing compressed gas on board the vehicle may be varied with time (e.g., by opening or closing one or more storage cylinders or vessels on board the vehicle). The compressed air discharged at a later time may utilize one or more of the power generation device/systems and peripherals provided on board the vehicle. In some cases, one or more alternative or additional power generation devices/systems and peripherals may be provided as part of a stationary home and/or commercial power station, and may be coupled to the pressure regulating vessel, the storage cylinders/vessels and/or other components on board the vehicle. In yet other cases, the pressure regulating vessel and/or storage cylinders/vessels may be removed from the vehicle and couple to a standalone home and/or commercial power station.

Further embodiments include using the compressed air generated by the devices and systems of the disclosure for potential energy storage (e.g., pumping) and/or various forms of inelastic energy storage. For example, the compressed air may be used to compress one or more other materials (e.g., one or more other hydraulic or other fluids, elastic and/or inelastic materials, a spring, etc.). In some examples, the compressed air may be used to directly or indirectly transfer energy to one or more devices, such as, for example, a flywheel.

FIG. 3 is a cross-sectional view perpendicular to the axis of rotation of the air compressing tire in FIG. 1. The top portion of FIG. 3 is a sectional view of an upper portion of the air compressing tire that is not in contact with the road surface (12 o'clock non-compressing position). The bottom portion of FIG. 3 is a sectional view of a bottom portion of the air compressing tire that is in contact with the road surface (6 o'clock squeezing (crushing) position) and on which the weight of the vehicle against the road surface creates a deformation at the 6 o'clock road contact point 3, giving rise to the pinch point 7 of the compression tube 1. The deformation of the tire as a result of vehicle weight deformation may be evidenced by bulging side walls 18 of the tire at the road surface.

The compressing bladder 5 can be formed of a rigid or deformable material. The compressing bladder may be solid or hollow. The compressing bladder may or may not be inflatable. In some examples, the compressing bladder 5 is formed of a structure comprising rigid walls or solid composite material. For example, the structure may be formed of a resilient composite plastic material provided in a doughnut ring configuration inside the tire.

The compressing bladder 5 can extend from the tire rim 17 to the compression tube 1. The compressing bladder can be formed from a rigid rubber or composite material, such as, for example, high load air-filled bags made from rubber compounds reinforced with aramide fibres. Alternatively, other strong, lightweight and flexible materials may be used. Such materials may contain aluminum, steel, synthetic or natural fibers, carbon composite, various lightweight alloys and/or various polymer or rubber compounds. The compressing bladder may be inserted in a standard tire (e.g., a standard tire having a rubber tire tread 27) in order to provide a suitable compression surface against the tire rim and a rigid compression wall for the compression tube 1 to crush against. At least a portion 25 of the compressing bladder 5 may be molded. For example, as shown in FIG. 3, the compression bladder may have a first molded shape 25 to fit the interior of the tire rim 17 and a second molded flat projected surface 25 for at least partially or fully compressing (in some cases fully compressing) the compression tube 1 at the 6 o'clock position where the tire tread 27 contacts the road surface.

The compression tube 1 can be attached to the inside of the tire, for example, by vulcanizing the compression tube to the inside of the tire at a first location 28 and to the outside of the compressing bladder at a second location 28. Thus, as described elsewhere herein, when compression tube is vacated and crushed at the pinch point 7, the compression tube bounces back from its compressed state (thereby creating a vacuum in the compression tube) by being pulled apart by the attachment points 28 as the tire rotates past the pinch point 7 and the weight of the vehicle allows the tire to recover from its deformed state. In some cases, other methods for attaching the compression tube (and/or the compressing bladder) inside the tire may be used, including any methods known in the art for attaching polymeric, rubber, elastic, fibrous and composite materials. Additionally, the compression tube may be attached in one or more locations in addition or alterative to the locations 28 shown in FIG. 3 (e.g., the compression tube may be attached to one or more sides of the tire). The compression tube 1 may not be molded into the tire or the tire tread 27 to avoid interference with durability and traction/grip of the tire. In some embodiments, the compression tube can be made of Teflon®. In other embodiments, the compression tube can be made of any flexible, deformable material such as polymer or rubber materials (e.g., natural and synthetic polymers with or without reinforcement).

Also shown are the discharge stem 8 (shown in the plane of the figure) and the intake intake stem 2. The discharge stem 8 and the intake intake stem 2 can each be mounted in a given configuration. The individual mounting configurations for the discharge stem 8 and the intake stem 2 can be identical, similar, or different from each other. For example, the lengths and/or orientations of the stems 2 and 8 can differ. Any of the stems for intake and discharge of air described herein (e.g., discharge stems 8 and intake stems 2 in FIGS. 1, 2, 3 and 4) can be mounted in the configurations shown for the discharge stem 8 and/or the intake stem 2 in FIG. 3. Alternatively, the stems can be mounted in one or more different configurations (e.g., the intake stems can be mounted in a first configuration and the discharge stems can be mounted in a second configuration, one or more individual intake stems and/or one or more individual discharge stems can be mounted in different configurations, etc.). In some embodiments, one or more of the stems are mounted on the side of the compression tube 1 facing the tire sides rather than perpendicular to the tire tread as shown in FIGS. 1, 2 and 3.

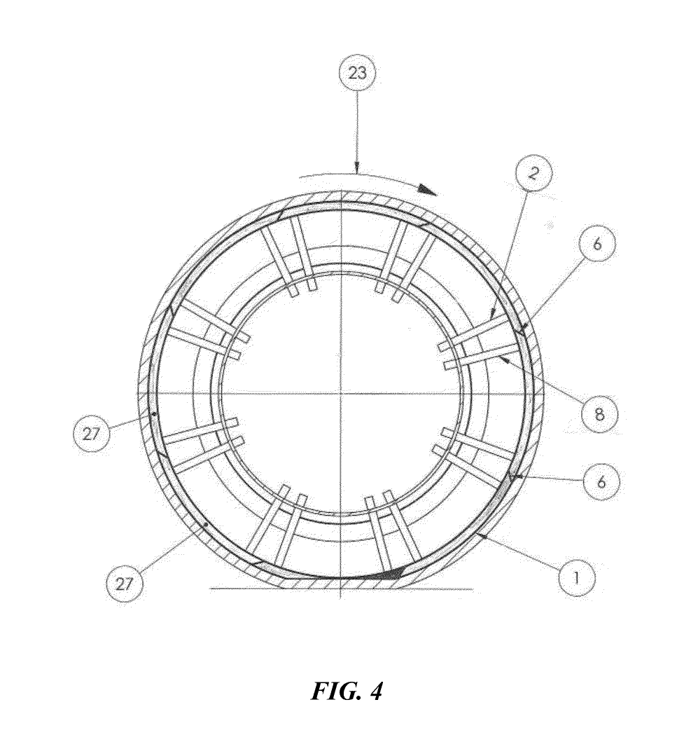

FIG. 4 is a cross-sectional side view of a rotating air compressing tire with multiple compression cells 1. Each compressing cell 1 can function as an independent compression tube; thus, this arrangement may correspond to multiple (separate) compression tube segments arranged in series. Each compression tube or cell 1 may be attached to an individual discharge stem 8 and an individual intake stem 2. Thus, during a single tire revolution, multiple compressions and intakes take place (equal to the number of compression tubes or cells). In some embodiments, the compression cells may not have the same shape (i.e., the compression cells may not be identical compression tubes arranged in series). For example, the compression tubes or cells may be individual compression chambers; thus, the air compression achieved in each compression chamber may be different. The compression chambers may be spaced apart or adjacent to each other. The compression chambers may have different volumes. The compression chambers may have different relative locations of the stems 2 and 8. Individual compression chambers may have a uniform shape or a compound shape (e.g., varying dimensions along each compression chamber). Further, the compression chamber wall thickness may vary (e.g., a compression chamber with a high compression ratio may have thicker walls than a compression chamber with a low compression ratio). In some cases, the compression chambers may have different wall thicknesses along different surfaces. For example, the compression chambers may have different wall thicknesses on the surface facing the compressing bladder, the surface facing the tire sides and/or the surface facing the tire tread. The compression chambers may be made of different materials (e.g., materials with different flexibility), thus further allowing compression to be tailored in individual compression chambers. As used herein, the terms compression tube, compression cell and compression chamber may be used interchangeably; thus, any description herein in relation to compression tubes, compression cells or compression chambers may equally apply to compression tubes, compression cells or compression chambers individually at least in some configurations.

In some embodiments, the compression chambers may interact with one or more features on the inside of the tire. Such features may be provided on standard tires, or may be additionally inserted into a standard tire. For example, one or more inserts may be used to enhance compression at one or more of the compression chambers. The insert(s) may be provided, for example, between the compression chamber and the inside of the tire, or between the compression chamber and the compressing bladder. Further, the inserts or features may be affixed to the tire, the tire rim, the compressing bladder, the compression chamber, or any combination thereof using any of the techniques known in the art and/or described herein.

During each intake-compression-discharge cycle, each compression chamber may be filled with ambient air from the filling stem 2. In some cases, ambient air intake to the compression chamber may be assisted (or replaced) by venting compressed air (or other gas(es)) from the pressure regulating vessel 10 into the compression chamber. The air inside each compression chamber can be compressed due to the weight of the vehicle at the road contact point 3 (i.e., at the pinch point 7) as the tire section with the compression chamber rotates past the road surface and pushes the air inside the compression chamber against the dam or seal 6 as a result of the dynamics of the vehicle's weight and/or forward inertia. The compressed air from each compression chamber can be discharged by the discharge stem 8 to the pressure regulating vessel 10, as described in more detail elsewhere herein. In some embodiments, the discharge stems of one or more compression chambers may be attached to joint tubing for discharging compressed air to the pressure regulating vessel. For example, 1, 2, 3, 4, 5, 10, 15, 20, 25, 50, 100, 200, 300, 400, 500, 1000 or more compression chambers may share an outlet tubing (e.g., tubing 20 in FIG. 1). By repeating the intake-compression-discharge cycle in each compression chamber, air is continuously sucked in, compressed and discharged from the compression chambers inside the tires to the pressure regulating vessel.

Further, in some embodiments, air intake to and air discharge from the compression chambers may be controlled (e.g., individually or globally). For example, air intake may be allowed to proceed such that compression chambers are filled to capacity. Alternatively, air intake may be interrupted such that air intake may not be fully completed. Further, air intake may not be allowed (e.g., blocked) in some situations. Similarly, air discharge may be allowed to proceed fully, or interrupted prematurely. For example, air discharge can be regulated (e.g., using a back-pressure regulator or orifice on the discharge stem 8). In some situations, the orifice can remain open, such that air is not compressed in the compression chamber. In some situations, the orifice can be regulated to provide a given air compression in the compression chamber. For example, the orifice can be at least partially or fully open at low vehicle or rotation speeds (e.g., below about 20 miles per hour (mph), or below about 35 mph), and closed (e.g., gradually or to a given position) at higher vehicle or rotation speeds. Such control of the intake and discharge of the air charge inside the compression chambers may allow additional flexibility in regulating the pressure of the compressed air from the tires.

The air intake to and air discharge from the compression chambers, discharge of air from the tires to the pressure regulating vessel, venting of compressed air from the pressure regulating vessel to the tires and/or other functions of the air compressing tires may be regulated electronically. For example, check valves and/or solenoid valves may be used to coordinate various fluid flows. Furthermore, fluid flow and pressure regulation may be monitored and/or optimized using an electronic control unit. The electronic control unit may have a user interface. The user interface for the electronic control unit may be on the exterior of the vehicle or it may be in the interior cab of the vehicle, such as in the dashboard display, in the vehicle center console, or in another location accessible to the vehicle operator.

As described in greater detail elsewhere herein, size and configuration of individual pressure chambers can be tailored to achieve a predetermined compressed air pressure. For example, as the air is compressed in the compression tube in FIG. 1, the air pressure increases continuously the confining space 19 shrinks Thus, as a first portion (e.g., first third) of the compression tube is compressed, a first (low) air pressure may be achieved. As a second portion (e.g., second third) of the compression tube is compressed, a second (intermediate) air pressure may be achieved. As a third portion (e.g., third third) of the compression tube is compressed, a third (high) air pressure may be achieved. The air pressure may or may not increase linearly with the extent of the compression tube being compressed. The profile of the pressure rise as a function of the portion of the compression tube compressed may be a function of compression tube (or cell or chamber) size, shape, material, uniformity, etc. For example, the maximum air pressure achievable may be limited by material choice. Furthermore, the dimensions and configuration of the compressing bladder, vehicle weight, intake and release pressure control, and/or other factors may also influence the achievable compressed air pressure.

In one example, a Teflon® air compression tube can deliver a compressed air pressure of about 150 pounds per square inch gauge (psig). The compressed air can be routed directly to an air motor capable of operating at an inlet pressure of about 150 psig. Alternatively, the compressed air can be routed to the pressure regulating vessel 10. In some examples, individual compression tubes/cells/chambers may supply compressed air at a pressure of at least about 1 psig, 5 psig, 10 psig, 15 psig, 20 psig, 25 psig, 30 psig, 45 psig, 50 psig, 60 psig, 70 psig, 80 psig, 90 psig, 100 psig, 110 psig, 120 psig, 130 psig, 140 psig, 160 psig, 170 psig, 180 psig, 190 psig, 200 psig, 300 psig, 400 psig, 500 psig, 600 psig, 700 psig, 800 psig, 900 psig or 1000 psig.

FIG. 5 is perspective view of a run flat tire with a run flat ring 29 attached to the tire rim inside the tire. The air compressing devices and systems of the present disclosure can be placed inside a vehicle's standard tires, such as a run flat tire. Consequently, the safety of the tire is not compromised as the footprint (e.g., contact surface area) of the tire on the road surface is not altered. The air compressing devices and systems of the present disclosure are placed inside the tire rather than inside the tire tread or on the tire tread, since the latter can change the safety characteristic of the tire by incorporating an exterior feature between the tire tread and the road surface.

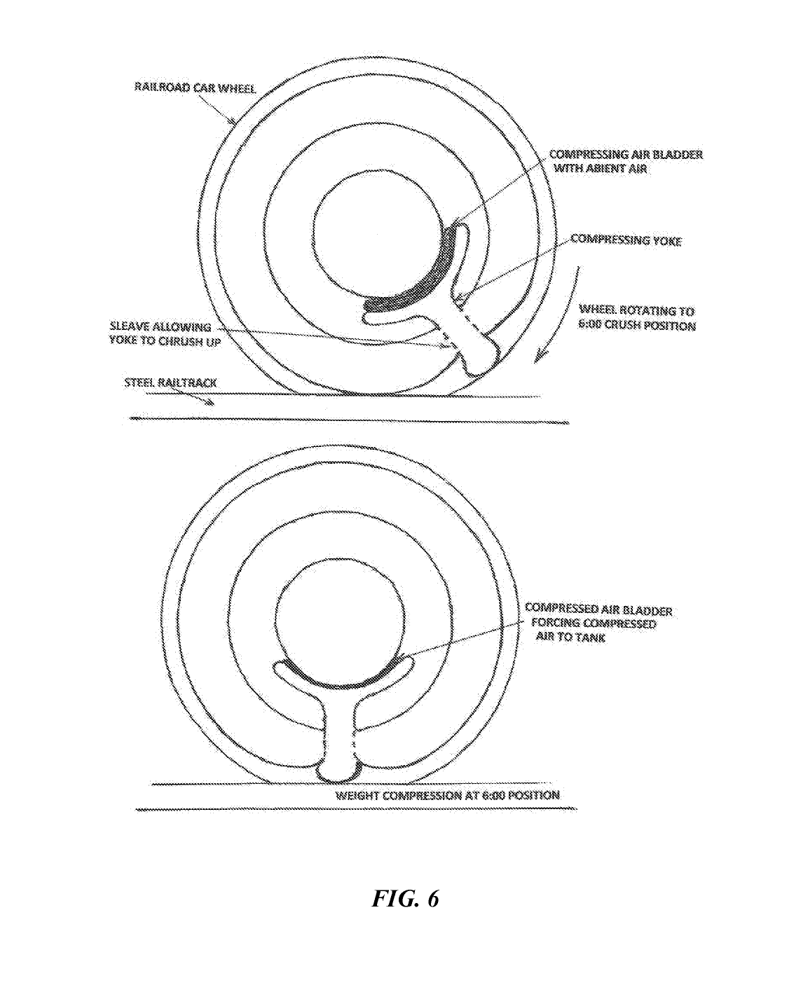

FIG. 6 shows cross-sectional side views of a rotating railroad car wheel with a compressing yoke. The figure shows an inner rotor that is coupled to the yoke through a compression chamber (or bladder). On a steel, other metal or composite railroad car wheel, railroad car weight force compresses the compression chamber against a yoke (or push rod). The yoke can compress air (e.g., ambient air) in the compression chamber to generate pressurized air. Air is compressed by the weight force from the vehicle.

It is to be understood that the terminology used herein is used for the purpose of describing specific embodiments, and is not intended to limit the scope of the present invention. It should be noted that as used herein, the singular forms of “a”, “an” and “the” include plural references unless the context clearly dictates otherwise. In addition, unless defined otherwise, all technical and scientific terms used herein have the same meaning as commonly understood by one of ordinary skill in the art to which this invention belongs.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

What is claimed is:

1. An air compressing system onboard a vehicle, comprising:
(a) a tire comprising:
(i) a rim;
(ii) a compressing bladder circumscribing at least a portion of said rim;
(iii) a compression chamber circumscribing at least a portion of said compressing bladder, wherein said compression chamber is configured to generate compressed air by a force from the vehicle that is transmitted to the compression chamber by the compressing bladder; and
(b) a fluid flow path in fluid communication with said compression chamber, wherein said fluid flow path is for transferring air from the compression chamber to the vehicle during motion of said vehicle.

2. The air compressing system of claim 1, wherein the tire is a standard tire or a railroad car wheel.

3. The air compressing system of claim 1, further comprising one or more additional tires each comprising an additional rim, an additional compressing bladder circumscribing at least a portion of said additional rim, and an additional compression chamber circumscribing at least a portion of said additional compressing bladder.

4. The air compressing system of claim 3, wherein said one or more additional tires comprise at least two additional tires.

5. The air compressing system of claim 1, further comprising an additional compression chamber.

6. The air compressing system of claim 5, wherein said additional compression chamber is in fluid communication with said fluid flow path or an additional fluid flow path.

7. The air compressing system of claim 5, wherein said additional compression chamber circumscribes at least a portion of said compressing bladder or an additional compressing bladder.

8. The air compressing system of claim 1, wherein the compression bladder is rigid.

9. The air compressing system of claim 1, wherein the fluid flow path is a closed circulatory fluid flow path.

10. The air compressing system of claim 1, further comprising a power generation system that is in fluid communication with said fluid flow path, which power generation system generates power upon fluid flow through said fluid flow path with the aid of said compressed air.

11. The air compressing system of claim 1, wherein said vehicle is an automobile or a train.

12. The air compressing system of claim 1, wherein said compressing bladder is formed of a polymeric material, a metallic material, or a composite material.

13. The air compressing system of claim 1, wherein said compressing bladder is hollow.

14. The air compressing system of claim 1, wherein said compressing bladder is solid.

15. A power generation system onboard a vehicle, comprising:
(a) a vehicle tire comprising (i) a rim, (ii) a compressing bladder circumscribing at least a portion of said rim, and (iii) a compression chamber circumscribing at least a portion of said compressing bladder, wherein rotation of said vehicle tire generates a periodic force that is directed to said compression chamber through said compressing bladder, which force compresses fluid in said compression chamber;
(b) a fluid flow path in fluid communication with said compression chamber, wherein said fluid flow path is adapted to direct compressed fluid out of said compression chamber; and
(c) a power generation system that is in fluid communication with said compression chamber through said fluid flow path, wherein said power generation system is adapted to generate power upon fluid flow through said fluid flow path, which fluid flow is generated upon compression of fluid in said compression chamber upon rotation of said vehicle tire.

16. The system of claim 15, wherein the tire is a standard tire or a railroad car wheel.

17. The system of claim 15, wherein said compressing bladder is formed of a polymeric material, a metallic material, or a composite material.

18. The system of claim 15, wherein said compressing bladder is hollow.

19. The system of claim 15, wherein said compressing bladder is solid.

20. The system of claim 15, wherein said compression chamber is in fluid communication with the ambient environment through a first opening and in fluid communication with said fluid flow path through a second opening.

21. The system of claim 20, wherein said vehicle tire is configured and adapted such that, during said rotation of said vehicle tire, fluid is directed into said compression chamber through said first opening upon displacement of fluid from said compression chamber into said fluid flow path through said second opening.

22. A method for generating power onboard a vehicle, comprising:
providing a vehicle comprising at least one tire including (i) a rim, (ii) a compressing bladder circumscribing at least a portion of said rim, (iii) a compression chamber circumscribing at least a portion of said compressing bladder, and (iv) a fluid flow path in fluid communication with said compression chamber and a power generation system, which power generation system generates power upon fluid flow through said fluid flow path;
effecting rotation of said tire to effect the compression of said compressing bladder against said rim, thereby displacing fluid from the compression chamber into said fluid flow path; and
directing said fluid displaced from the compression chamber to said power generation system through said fluid flow path, to generate power upon said rotation of said tire.

23. The method of claim 22, wherein during rotation of said tire, fluid in said compression chamber is compressed and discharged to a pressure regulating vessel on board said vehicle and in fluid communication with said fluid flow path.

24. The method of claim 22, wherein said compression chamber is in fluid communication with the ambient environment through a first opening and in fluid communication with said fluid flow path through a second opening.

25. The method of claim 24, wherein during said rotation, fluid is directed into said compression chamber through said first opening upon displacement of fluid from said compression chamber into said fluid flow path through said second opening.

26. The method of claim 23, wherein said first opening and/or said second opening is a one-way valve, wherein the on-way valve permits flow of fluid only in one flow direction.

27. The method of claim 22, wherein said vehicle is an automobile or a train.
